(19) United States
(12) Patent Application Publication
(10) Pub. No.: US 2020/0041829 A1
(43) Pub. Date: Feb. 6, 2020

(54) PIXEL UNIT AND DISPLAY SUBSTRATE

(71) Applicant: SHENZHEN CHINA STAR OPTOELECTRONICS SEMICONDUCTOR DISPLAY TECHNNOLOGY CO., LTD., Shenzhen, Guangdong (CN)

(72) Inventors: Qiming GAN, Shenzhen, Guangdong (CN); Meng WANG, Shenzhen, Guangdong (CN)

(21) Appl. No.: 15/740,004

(22) PCT Filed: Nov. 10, 2017
(86) PCT No.: PCT/CN2017/110308

§ 371 Date: Dec. 27, 2017

(30) Foreign Application Priority Data
Oct. 26, 2017 (CN) 201711012017.9

(51) Int. Cl. G02F 1/1368; G02F 1/1343; G02F 1/1362

(52) U.S. Cl. CPC G02F 1/1368; G02F 1/136213; G02F 1/1343

(57) ABSTRACT

A pixel unit and a display substrate are provided. The pixel unit has at least two sub-pixels arranged along a first direction or a second direction within a liquid crystal display panel, and each of the sub-pixels comprises a first area, a second area, and a third area, wherein a source/drain of the third-area thin film transistor connects to a third-area common electrode, and the third-area common electrode connects to a second input.

### FIELD OF INVENTION

The present disclosure relates to a technical field of liquid crystal displays, and in particular to a pixel unit and a display substrate.

### BACKGROUND OF INVENTION

Liquid crystal display (LCD) devices are the most widely used in the display product market, where production technology is mature and has a high product yield, production costs are relatively low, and high market acceptance.

A liquid crystal display panel is composed of a color filter substrate, a thin film transistor array substrate, and a liquid crystal layer disposed between two substrates. A pixel electrode and a common electrode are respectively disposed on the opposite inner sides of the two substrates. Light of the backlight module is refracted to generate an image by applying a voltage to control liquid crystal molecules to change direction. Liquid crystal displays include various display modes, such as twisted nematic (TN) mode, electronically controlled birefringence (ECB) mode, and vertical alignment (VA) mode, wherein the VA mode is a common display mode with high contrast, wide viewing angle, and has no need for frictional alignment. However, because the VA mode uses liquid crystals that rotate vertically, the birefringence of liquid crystal molecule difference is relatively large. It leads to a serious color shifting problems in a large viewing angle.

With development of liquid crystal display technology, display screens are getting larger in size. Conventional polymer stabilized vertical alignment (PSVA) pixels with 4 domains can make poor performance of viewing angle shifts is prominent. In order to enhance panel perspective performance, 3T_8domain (8 domain 3 transistor) PSVA pixels are applied to large-size TV panel so that rotation angles of the liquid crystal molecules of the four domains in the main area and the four domains in the sub-area in the same sub pixel are different from each other, thereby improving the color shift.

As shown in NG. 1, which is a circuit diagram of, a pixel unit in a prior art. A plurality of sub-pixels in the liquid crystal display panel are arranged in an array, wherein each of the sub-pixels can be divided into a main area and a sub-area and comprises a main-area thin film transistor TFT_m, a main-area LCD capacitor Clc_m, a main storage capacitor Cst_m, a sub-area thin film transistor TFT_s, a sub-area LCD capacitor Clc_s, a sub-area storage capacitor Cst_s, and a shared thin film transistor TFT_share. Each row of the sub-pixels is provided with a scanning line Gate, and each column of the sub-pixels is provided with a data line Data. A gate of the main-area thin film transistor TFT_m connects to the scanning line Gate. One of a source/drain of the main-area thin film transistor TFT_m connects to the data line Data, and the other of source/drain of the main-area thin film transistor TFT_m and a common electrode A_com (or C_com) connects in parallel to the main-area LCD capacitor Clc_m and the main-area storage capacitor Cst_m. A gate of sub-area thin film transistor TFTs connects to the scanning line Gate. One of a source/drain of the sub-area thin film transistor TFTs connects to the data line Data. The other of source/drain of the sub-area thin film transistor TFT_s and a common electrode A_com (or C_com) connect in parallel to the sub-area LCD capacitor Clc_s, and the sub-area storage capacitor Cst_s. A gate of the shared thin film transistor TFT_share connects to the scanning line Gate. A source and a drain of the shared thin film transistor TFT_share connect to the source/drain of sub-area thin film transistor TFT_s and the common electrode A_com, respectively. Those skilled in the art can understand that the names of common electrodes A_com and C_com are different, but the potentials of common electrodes are usually the same in the liquid crystal panel. Therefore, it can be represented by the common electrode A_com. For the thin film transistors, the characteristics of the source and the drain are the same, and the source and the drain are not specifically limited in the circuit. In the three-dimensional structure of the liquid crystal display panel. The two electrodes of the liquid crystal capacitor and the storage capacitor generally correspond to the pixel electrode (or the storage electrode with the same potential as the pixel electrode) and the common electrode.

In 3T pixels, the sub-area is discharged by connecting the sub-area pixel to A_com through the third TFT. A potential difference is formed between the main area and the sub-area to achieve the main area and the sub-area of the liquid crystal is inconsistent, and the perspective compensation can be achieved. However, the potential stability of the common electrode A_com is important for implement of LCD pixels, wherein 3T is connected directly to A_com, and the potential stability of the common electrode A_com would be affected during 3T discharge, thereby affecting the stability of the liquid crystal display.

### SUMMARY OF INVENTION

An object of the present disclosure is to provide a pixel unit and a display substrate, which solves the problem that the discharge of 3T pixel unit affects the stability of the common electrode and the stability of the liquid crystal display.

A pixel unit is provided, which comprises at least two sub-pixels arranged along a first direction or a second direction within a liquid crystal display panel. Each of the sub-pixels comprises a first area, a second area, and a third area. The first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor. The first-area storage capacitor includes a first-area storage electrode and a first-area common electrode; the second-area storage capacitor includes a second-area storage electrode and a second-area common electrode; the first-area common electrode and the second-area common electrode connect to a first input. A gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input. The pixel unit is a pixel unit of an eight-domain and three thin film transistors, wherein the first area and the second area correspond to four-domain liquid crystal molecules.

In one embodiment of the present disclosure, each row of the sub-pixels is provided with a scanning line in the first direction, and the scanning line is located between the first area and the second area; each column of the sub-pixels is provided with a data line in the second direction.

In one embodiment of the present disclosure, a gate of the first-area thin film transistor connects to the scanning line; one of a source/drain of the first-area thin film transistor connects to the data line; the other of the source/drain of the first-area thin film transistor connects to the first-area storage electrode or a first-area pixel electrode; a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

In one embodiment of the present disclosure, the first-area storage electrode and the second-area storage electrode are formed from the same metal layer; the gate of the first-area thin film transistor, the gate of the second-area thin film transistor, the gate of the third-area thin film transistor, and the scanning lines are formed from the same metal layer; the source/drain of the first-area thin film transistor, the source/drain of the second-area thin film transistor, the source/drain of the third-area thin film transistor, and the data lines are formed from the same metal layer.

A display substrate is provided, which comprises a pixel unit comprising at least two sub-pixels arranged along a first direction or a second direction within a liquid crystal display panel. Each of the sub-pixels comprises a first area, a second area, and a third area; the first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor. The first-area storage capacitor includes a first-area storage electrode and a first-area common electrode; the second-area storage capacitor includes a second-area storage electrode and a second-area common electrode; the first-area common electrode and the second-area common electrode connect to a first input. A gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input.

In one embodiment of the present disclosure, each row of the sub-pixels is provided with a scanning line in the first direction, and the scanning line is located between the first area and the second area; each column of the sub-pixels is provided with a data line in the second direction.

In one embodiment of the present disclosure, a gate of the first-area thin film transistor connects to the scanning line; one of a source/drain of the first-area thin film transistor connects to the data line; the other of the source/drain of the first-area thin film transistor connects to the first-area storage electrode or a first-area pixel electrode; a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

In one embodiment of the present disclosure, the pixel unit is a pixel unit of an eight-domain and three thin film transistors, wherein the first area and the second area correspond to four-domain liquid crystal molecules.

In one embodiment of the present disclosure, the first-area storage electrode and the second storage electrode are formed from the same metal layer; the gate of the first-area thin film transistor, the gate of the second-area thin film transistor, the gate of the third-area thin film transistor, and the scanning lines are formed from the same metal layer; the source/drain of the first-area thin film transistor, the source/drain of the second-area thin film transistor, the source/drain of the third-area thin transistor, and the data lines are formed from the same metal layer.

A pixel unit is provided, which comprises at least two sub-pixels arranged along a first direction or a second direction within a liquid crystal display panel. Each of the sub-pixels comprises a first area, a second area, and a third area; the first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor. The first-area storage capacitor includes a first-area storage electrode and a first-area common electrode: the second-area storage capacitor includes a second-area storage electrode and a second-area common electrode; the first-area common electrode and the second-area common electrode connect to a first input A gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input.

In one embodiment of the present disclosure, each row of the sub-pixels is provided with a scanning line in the first direction, and the scanning line is located between the first area and the second area; each column of the sub-pixels is provided with a data line in the second direction.

In one embodiment of the present disclosure, a gate of the first-area thin film transistor connects to the scanning line; one of a source/drain of the first-area thin film transistor connects to the data line; the other of the source/drain of the first-area thin film transistor connects to the first-area storage electrode or a first-area pixel electrode; a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

In one embodiment of the present disclosure, the first-area storage electrode and the second storage electrode are formed from the same metal layer; the gate of the first-area thin film transistor, the gate of the second-area thin film transistor, the gate of the third-area thin film transistor, and the scanning lines are formed from the same metal layer; the source/drain of the first-area thin film transistor, the source/drain of the second-area thin film transistor, the source/drain of the third-area thin film transistor, and the data lines are formed from the same metal layer.

The beneficial effect of the present disclosure compared with the prior art is that the third-area common electrode is provided in the existing 3T pixel unit, and third-area common electrode is independent of the first-area common electrode and the second-area common electrode and connects to the second input so that the potential of the third-area common electrode cannot be affected during 3T discharge. The third-area common electrode is controlled by the second input so that the potential stability of third-area common electrode is not be affected, and the stability of the liquid crystal display can ensured.

### DESCRIPTION OF DRAWINGS

In order to more clearly illustrate the embodiments or the prior art technical solutions embodiment of the present disclosure, will implement the following figures for the cases described in the prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a circuit diagram of a pixel unit in a prior art.

FIG. 2 is a circuit diagram of a pixel unit according a preferred embodiment of the present disclosure.

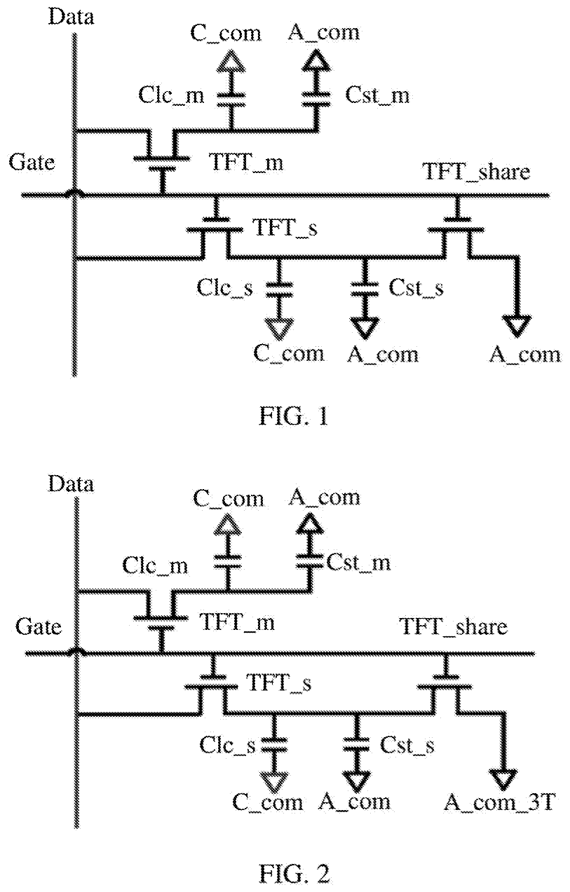

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

The existing 3T pixel unit, factors are produced to affect the stability of the common electrode during the discharge of the pixel unit so that the stability of liquid crystal display is affected. The embodiment of the present disclosure can solve this problem.

FIG. 2 shows a circuit diagram of a pixel unit according a preferred embodiment of the present disclosure, wherein the pixel unit comprises at least two sub-pixels, and the two sub-pixels are arranged along a first direction or a second direction within a liquid crystal display panel.

Each row of the sub-pixels is provided with a scanning line in the first direction, and the scanning line is located between a first area and a second area. Each column of the sub-pixels is provided with a data line in the second direction. In the embodiment, the first direction is a horizontal direction, and the second direction is a vertical direction.

Furthermore, each of the sub-pixels comprises a first area, a second area, and a third area. In the embodiment, the first area is a main area, the second area is a sub-area, and the third area is a shared area.

The first area is provided with a first-area thin film transistor, first-area LCD capacitor, and a first-area storage capacitor. The second area is provided with a second-area thin film transistor, a second-area LCD capacitor, and a second-area storage capacitor. The third area is provided with a third-area thin film transistor.

A gate of the first-area thin film transistor connects to the scanning line. One of a source/drain of the first-area thin film transistor connects to the data line. The other of the source/drain off the first-area thin film transistor connects to the first-area storage electrode or a first-area pixel electrode. In the embodiment, the source of the first-area thin film transistor connects to the data line, and the drain of the first-area thin film transistor is an output and connects the first-area storage electrode or a first-area pixel electrode.

A gate of the second-area thin film transistor connects to the scanning line. One of the source/drain of the second-area thin film transistor connects to the data line. The other of the source/drain of the second-area thin film transistor connects to the second-area storage electrode or a second-area pixel electrode. In the embodiment, the source of the second-area thin film transistor connects to the data line, and the drain of the second-area thin film transistor is an output and connects to the second-area storage electrode or a second-area pixel electrode.

The pixel unit is a pixel unit of an eight-domain and comprises the first area, the second area, and the third area, wherein the first area and the second area correspond to four-domain liquid crystal molecules.

The first-area storage electrode connects to a first-area common electrode via a hole. The first-area storage capacitor includes the first-area storage electrode and the first-area common electrode. A second-area storage electrode connects to a second-area common electrode via a hole. The second-area storage capacitor includes the second-area storage electrode and the second-area common electrode, wherein the first-area common electrode and the second-area common electrode connect to a first input.

The gate of the first-area thin film transistor, the gate of the second-area thin film transistor, the gate of the third-area thin film transistor, and the scanning lines are formed from a first metal layer through a first mask process. The source/drain of the first-area thin film transistor, the source/drain of the second-area thin film transistor, the source/drain of the third-area thin film transistor, and the data lines are formed from a second metal layer through a second mask process. The first-area storage electrode and the second-area storage electrode are formed from the same metal layer through a third mask process, wherein the first metal layer and the second metal layer, and the metal such as molybdenum, aluminum, aluminum-nickel alloy, molybdenum-tungsten alloy, chromium, copper or the like may be used, or a combination of the above-mentioned materials may be used.

A gate of the third-area thin film transistor connects to a scanning line corresponding to the sub-pixel. A source/drain of the third-area thin film transistor and a source/drain of the second-area thin film transistor are connected to each other. In addition, the source/drain of the third-area thin film transistor connects to a third-area common electrode. In the embodiment, the source of the third-area thin film transistor connects to the third-area common electrode, and the drain of the third-area thin film transistor and the drain of the second-area thin film transistor are connected to each other.

The third-area common electrode connects to a second input, and the second input is independent of the first output. The third-area common electrode is not affected by the first-area common electrode and the second-area common electrode.

As shown in FIG. 2, in the pixel unit, the first area is a main area and comprises a main-area thin film transistor TFT_m, a main-area LCD capacitor Clc_m, and a main-area storage capacitor Cst_m. The second area is a sub-area and comprises a sub-area thin film transistor TFT_s, a sub-area LCD capacitor Clc_s, and a sub-area storage capacitor Cst_s. The third area comprises a shared thin film transistor TFT_share.

In addition, each row of the sub-pixels is provided with a scanning line Gate, and each column of the sub-pixels is provided with a data line Data. A gate of the main-area thin film transistor TFT_m connects to the scanning line Gate. A source of the main-area thin film transistor TFT_m connects to the data line Data. A drain of the main-area thin film transistor TFT_m and a first-area common electrode A_com (or C_com) connect in parallel to the main-area LCD capacitor Clc_m and the main-area storage capacitor Cst_m. A gate of sub-area thin film transistor TFT_s connects to the scanning line Gate, A source of the sub-area thin film transistor TFTs connects to the data line Data. A drain of the sub-area thin film transistor TFTs and a second-area common electrode A_com (or C_com) connect in parallel to the sub-area LCD capacitor Clc_s and the sub-area storage capacitor Cst_s.

A gate of the shared thin film transistor TFT_share connects to the scanning line Gate. A source and a drain of the shared thin film transistor TFT_share connect to the source/drain of sub-area thin film transistor TFT_s and a third-area common electrode A_com_3T, respectively.

Compared to the prior art, the common electrode A_com connected to one of the source/drain of the shared thin film transistor TFT_share is replaced to the third-area common electrode A_com_3T in the present disclosure, wherein the third-area common electrode A_com_3T is independent of the first-area common electrode A_com and the second-area common electrode A_com.

In the 3T pixel unit, the sub-area can be connected to the common electrode A_com through the shared thin film transistor TFT_share to discharge the sub-area. A potential difference is formed between the main area and the sub-area so that the liquid crystal direction of the main area and the sub-area are not identical, and the perspective compensation can be achieved. Therefore, a potential stability of the common electrode A_com is important for implement of LCD pixels. Traditional common electrode is controlled from an input. It can be generated the potential stability of the common electrode A_com during the discharge so that an error in the input of the common electrode is generated, thereby affecting the stability of the liquid crystal display. The third-area common electrode A_com_3T is controlled by the second input, and is not affected during the discharge. The potential stability ensures the stability of liquid crystal display.

The present disclosure further provides a display substrate. The display substrate comprises a pixel unit comprising at least two sub-pixels arranged along a first direction or a second direction within a liquid crystal display panel.

Each row of the sub-pixels is provided with a scanning line in the first direction, and the scanning line is located between a first area and a second area. Each column of the sub-pixels is provided with a data line in the second direction. In the embodiment, the first direction is a horizontal direction and the second direction is a vertical direction.

Furthermore, each of the sub-pixels comprises a first area, a second area, and a third area. In, the embodiment, the first area is a main area, the second area is a sub-area, and the third area is a shared area.

The first area is provided with a first-area thin film transistor, a first-area LCD capacitor, and a first-area storage capacitor. The second area is provided with a second-area thin film transistor, a second-area LCD capacitor, and a second-area storage capacitor. The third area is provided with a third-area thin film transistor.

A gate of the first-area thin film transistor connects to the scanning line. One of a source/drain of the first-area thin film transistor connects to the data line. The other of the source/drain of the first-area thin film transistor connects to the first-area storage electrode or a first-area pixel electrode. In the embodiment, the source of the first-area thin film transistor connects to the data line, and the drain of the first-area thin film transistor is an output and connects the first-area storage electrode or a first-area pixel electrode.

A gate of the second-area thin film transistor connects to, the scanning line. One of the source/drain of the second-area thin film transistor connects to the data line. The other of the source/drain of the second-area thin film transistor connects to the second-area storage electrode or a second-area pixel electrode. In the embodiment, the source of the second-area thin film transistor connects to the data line, and the drain of the second-area thin film transistor is an output and connects to the second-area storage electrode or a second-area pixel electrode.

The pixel unit is a pixel unit of an eight-domain and comprises the first area, the second area, and the third area, wherein the first area and the second area correspond four-domain liquid crystal molecules, respectively.

The first-area storage electrode connects to a first-area common electrode via a hole. The first-area storage capacitor includes the first-area storage electrode and the first-area common electrode. A second-area storage electrode connects to a second-area common electrode via a hole. The second-area storage capacitor includes the second-area storage electrode and the second-area common electrode, wherein the first-area common electrode and the second-area common electrode connect to a first input.

The gate of the first-area thin film transistor, the gate of the second-area thin film transistor, the gate of the third-area thin film transistor, and the scanning lines are formed from a first metal layer through a first mask process. The source/drain of the first-area thin film transistor, the source/drain of the second-area thin film transistor, the source/drain of the third-area thin film transistor, and the data lines are formed from a second metal layer through a second mask process. The first-area storage electrode and the second-area storage electrode are formed from the same metal layer through a third mask process, wherein the first metal layer and the second metal layer, and the metal such as molybdenum, aluminum, aluminum-nickel alloy, molybdenum-tungsten alloy, chromium, copper or the like may be used, or a combination of the above-mentioned materials may be used.

A gate of the third-area thin film transistor connects to a scanning line corresponding to the sub-pixel. A source/drain of the third-area thin film transistor and a source/drain of the second-area thin film transistor are connected to each other. In addition, the source/drain of the third-area thin film transistor connects to a third-area common electrode. In the embodiment, the source of the third-area thin film transistor connects to the third-area common electrode, and the drain of the third-area thin film transistor and the drain of the second-area thin film transistor are connected to each other.

The third-area common electrode connects to a second input, and the second input is independent of the first output. The third-area common electrode is not affected by the first-area common electrode and the second-area common electrode.

The second embodiment of the present disclosure is similar to the first embodiment, and details are not described below.

The present disclosure is to provide a pixel unit and a display substrate, wherein the third-area common electrode is provided in the existing 3T pixel unit, and third-area common electrode is independent of the first-area common electrode and the second-area common electrode and connects to the second input so that the potential of the third-area common electrode cannot be affected during 3T discharge. The third-area common electrode is controlled by the second input so that the potential stability of third-area common electrode is not be affected, and the stability of the liquid crystal display can ensured.

The present disclosure has been described with preferred embodiments thereof and it is understood that many changes and modifications to the described embodiments can be carried out without departing from the scope and the spirit of the invention that is intended to, be limited only by the appended claims.

What is claimed is:

1. A pixel unit, comprising:
at least two sub-pixels arranged along a first direction or a second direction within a liquid crystal display panel;
wherein each of the sub-pixels comprises a first area, a second area, and a third area; the first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor;
wherein the first-area storage capacitor includes a first-area storage electrode and a first-area common electrode; the second-area storage capacitor includes a second-area storage electrode and a second-area common electrode; the first-area common electrode and the second-area common electrode connect to a first input;
wherein a gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input;
wherein the pixel unit is a pixel unit of an eight-domain and three thin film transistors, wherein the first area and the second area correspond to four-domain liquid crystal molecules.

2. The pixel unit according to claim 1, wherein each row of the sub-pixels is provided with a scanning line in the first direction, and the scanning line is located between the first area and the second area;
each column of the sub-pixels is provided with a data line in the second direction.

3. The pixel unit according to claim 1, wherein a gate of the first-area thin film transistor connects to the scanning line; one of a source/drain of the first-area thin film transistor connects to the data line; the other of the source/drain of the first-area thin film transistor connects to the first-area storage electrode or a first-area pixel electrode;
a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

4. The pixel unit according to claim 1, wherein the first-area storage electrode and the second-area storage electrode are formed from the same metal layer;
the gate of the first-area thin film transistor, the gate of the second-area thin film transistor, the gate of the third-area thin film transistor, and the scanning lines are formed from the same metal layer;
the source/drain of the first-area thin film transistor, the source/drain of the second-area thin film transistor, the source/drain of the third-area thin film transistor, and the data lines are formed from the same metal layer.

5. A display substrate, comprising:
a pixel unit comprising at least two sub-pixels arranged along a first direction or a second direction within a liquid crystal display panel;
wherein each of the sub-pixels comprises a first area, a second area, and a third area; the first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor;
wherein the first-area storage capacitor includes a first-area storage electrode and a first-area common electrode; the second-area storage capacitor includes a second-area storage electrode and a second-area common electrode; the first-area common electrode and the second-area common electrode connect to a first input;
wherein a gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input.

6. The display substrate according to claim 5, wherein each row of the sub-pixels is provided with a scanning line in the first direction, and the scanning line is located between the first area and the second area;
each column of the sub-pixels is provided with a data line in the second direction.

7. The display substrate according to claim 5, wherein a gate, of the first-area thin film transistor connects to the scanning line; one of a source/drain of the first-area thin film transistor connects to the data line; the other of the source/drain of the first-area thin film transistor connects to the first-area storage electrode or a first-area pixel electrode;
a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

8. The display substrate according to claim 5, wherein the pixel unit is a pixel unit of an eight-domain and three thin film transistors, wherein the first area and the second area correspond four-domain liquid crystal molecules, respectively.

9. The display substrate according to claim 5, wherein the first-area storage electrode and the second storage electrode are formed from the same metal layer;
the gate of the first-area thin film transistor, the gate of the second-area thin film transistor, the gate of the third-area thin film transistor, and the scanning lines are formed from the same metal layer;
the source/drain of the first-area thin film transistor, the source/drain of the second-area thin film transistor, the source/drain of the third-area thin film transistor, and the data lines are formed from the same metal layer.

10. A pixel unit, comprising:
at least two sub-pixels arranged along a first direction or a second direction within a liquid crystal display panel;
wherein each of the sub-pixels comprises a first area, a second area, and a third area; the first area is provided with a first-area thin film transistor, a first-area LCD capacitor, and a first-area storage capacitor; the second area is provided with a second-area thin film transistor, a second-area LCD capacitor, and a second-area storage capacitor; the third area is provided with a third-area thin film transistor;
wherein the first-area storage capacitor includes a first-area storage electrode and a first-area common electrode; the second-area storage capacitor includes a second-area storage electrode and a second-area common electrode; the first-area common electrode and the second-area common electrode connect to a first input;
wherein a gate of the third-area thin film transistor connects to a scanning line corresponding to the sub-pixel; a source/drain of the third-area thin film transistor and a source/drain of the second-area thin film transistor are connected to each other; the source/drain of the third-area thin film transistor connects to a third-area common electrode; the third-area common electrode connects to a second input.

11. The pixel unit according to claim 10, wherein each row of the sub-pixels is provided with a scanning line in the first direction, and the scanning line is located between the first area and the second area;
each column of the sub-pixels is provided with a data line in the second direction.

12. The pixel unit according to claim 10, wherein a gate of the first-area thin film transistor connects to the scanning line; one of a source/drain of the first-area thin film transistor connects to the data line; the other of the source/drain of the first-area thin film transistor connects to the first-area storage electrode or a first-area pixel electrode;
a gate of the second-area thin film transistor connects to the scanning line; one of the source/drain of the second-area thin film transistor connects to the data line; the other of the source/drain of the second-area thin film transistor connects to the second-area storage electrode or a second-area pixel electrode.

13. The pixel unit according to claim 10, wherein the first-area storage electrode and the second storage electrode are formed from the same metal layer;
the gate of the first-area thin film transistor, the gate of the second-area thin film transistor, the gate of the third-area thin film transistor, and the scanning lines are formed from the same metal layer;
the source/drain of the first-area thin film transistor, the source/drain of the second-area thin film transistor, the source/drain of the third-area thin film transistor, and the data lines are formed from the same metal layer.
